(19) United States
(12) Patent Application Publication
(10) Pub. No.: US 2016/0078685 A1
(43) Pub. Date: Mar. 17, 2016

(54) DISPLAY CONTROL DEVICE, DISPLAY CONTROL METHOD, AND RECORDING MEDIUM

(71) Applicant: SONY CORPORATION, Tokyo (JP)

(72) Inventors: Yasuyuki KOGA, Kanagawa (JP); Tetsuo IKEDA, Tokyo (JP); Atsushi IZUMIHARA, Kanagawa (JP); Takuo IKEDA, Tokyo (JP); Kentaro KIMURA, Tokyo (JP); Tsubasa TSUKAHARA, Tokyo (JP)

(73) Assignee: SONY CORPORATION, Tokyo (JP)

(21) Appl. No.: 14/888,788

(22) PCT Filed: Apr. 10, 2014
(86) PCT No.: PCT/JP2014/002065

§ 371 Date: Nov. 3, 2015

(30) Foreign Application Priority Data
May 15, 2013 (JP) 2013-102884

(51) Int. Cl. G06T 19/00; G06F 3/00; G06F 3/01; H04N 13/04

(52) U.S. Cl. CPC G06T 19/006; H04N 13/044; G06F 3/005; G06F 3/017

(57) ABSTRACT

There is provided a display control device including a viewpoint acquisition unit configured to acquire a viewpoint of a user detected by a viewpoint detection unit; and a display control unit configured to control a display unit so that a virtual object is stereoscopically displayed by the display unit. The display control unit is configured to control a position in a depth direction of the virtual object presented to the user based on the viewpoint.

### CROSS REFERENCE TO RELATED APPLICATIONS

This application claims the benefit of Japanese Priority Patent Application JP 2013-102884 filed May 15, 2013, the entire contents of which are incorporated herein by reference.

### TECHNICAL FIELD

The present disclosure relates a display control device, a display control method, and a recording medium.

### BACKGROUND ART

Recently, the development of HMDs (head mounted displays) as a display mounted on the head portion of a user has been progressing. A display operation of content by HMD mounted on the head of the user may be fixed regardless of the user's situation, or may be controlled based on the user's situation. For example, a technology for controlling the display operation of content based on the user's situation has been disclosed (e.g., refer to Patent Literature 1).

### CITATION LIST

### Patent Literature

PTL 1: JP 2008-65169A

### SUMMARY

### Technical Problem

However, an HMD that presents a virtual object to the user based on a stereoscopic display has also been developed. Accordingly, it is desirable for a technology to be realized that enables a stereoscopic display of a virtual object to be carried out that it is easier for the user to view.

### Solution to Problem

According to an embodiment of the present disclosure, there is provided a display control device including a viewpoint acquisition unit configured to acquire a viewpoint of a user detected by a viewpoint detection unit, and a display control unit configured to control a display unit so that a virtual object is stereoscopically displayed by the display unit. The display control unit is configured to control a position in a depth direction of the virtual object presented to the user based on the viewpoint.

According to an embodiment of the present disclosure, there is provided a display control method including acquiring a viewpoint of a user detected by a viewpoint detection unit, controlling a display unit so that a virtual object is stereoscopically displayed by the display unit, and controlling a position in a depth direction of the virtual object presented to the user based on the viewpoint.

According to an embodiment of the present. disclosure, there is provided a non-transitory computer-readable recording medium having a program recorded thereon that causes a computer to function as a display control device, the display control device including a viewpoint acquisition unit configured to acquire a viewpoint of a user detected by a viewpoint detection unit, and a display control unit configured to control a display unit so that a virtual object is stereoscopically displayed by the display unit. The display control unit is configured to control a position in a depth direction of the virtual object presented to the user based on the viewpoint.

### Advantageous Effects of Invention

According to an embodiment of the present disclosure, there is provided a technology that enables a stereoscopic display of a virtual object to be carried out that it is easier for the user to view.

### BRIEF DESCRIPTION OF DRAWINGS

FIG. 1 is a diagram illustrating a configuration example of an information processing system according to an embodiment of the present disclosure.

FIG. 2 is a diagram illustrating a function configuration example of an information processing system according to an embodiment of the present disclosure.

FIG. 3 is a diagram illustrating an example of a method for controlling a position in a depth direction of a virtual object presented to a user.

FIG. 4 is a diagram illustrating an example of presentation of a weather forecast screen to a user when stationary.

FIG. 5 is a diagram illustrating all example of presentation of a weather forecast screen to a user when walking.

FIG. 6 is a diagram illustrating an example of presentation of a weather forecast screen to a user when running.

FIG. 7 is a diagram illustrating an example of presentation of a weather forecast screen to a user when driving.

FIG. 8 is a diagram illustrating an example of presentation of a navigation screen to a user when stationary.

FIG. 9 is a diagram illustrating an example of presentation of a navigation screen to a user when walking.

FIG. 10 is a diagram illustrating an example of presentation of a navigation screen to a user when walking.

FIG. 11 is a diagram illustrating an example of presentation of a running application screen to a user when stationary.

FIG. 12 is a diagram illustrating an example of presentation of a running application screen to a user when walking.

FIG. 13 is a diagram illustrating an example of presentation of a running application screen to a user when running.

FIG. 14 is a diagram illustrating an example of controlling a display position of a virtual object based on luminance information about a captured image.

FIG. 15 is a diagram illustrating an example of controlling a display position of a virtual object based on color information about a captured image.

FIG. 16 is a diagram illustrating an example of controlling a shading amount based on luminance information about a captured image.

FIG. 17 is a diagram illustrating an example of controlling a shading amount based on luminance information about a captured image.

FIG. 18 is a flowchart illustrating a flow of operations in a display control device according to an embodiment of the present disclosure.

FIG. 19 is a diagram illustrating a hardware configuration example of a display control device according to an embodiment of the present disclosure.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in this specification and the appended drawings, structural elements that have substantially the same function and structure are in some cases differentiated by denoting with different alphabet letters provided after the same reference numeral. However, in cases where it is not necessary to distinguish among a plurality of structural elements having substantially the same function and structure, such structural elements are denoted using just the same reference numeral.

Further, the “Description of Embodiments” will be described below based on the following item order.

1. Embodiments

1-1. Configuration Example of Information Processing System

1-2. Function Configuration Example of Information Processing System

1-3. Function Details of Display Control Device

1-4. Display Control Device Operations

1-5. Hardware Configuration Example

2. Summary

<1. Embodiments>

First, an embodiment of the present disclosure will be described.

1-1. Configuration Example of Information Processing System

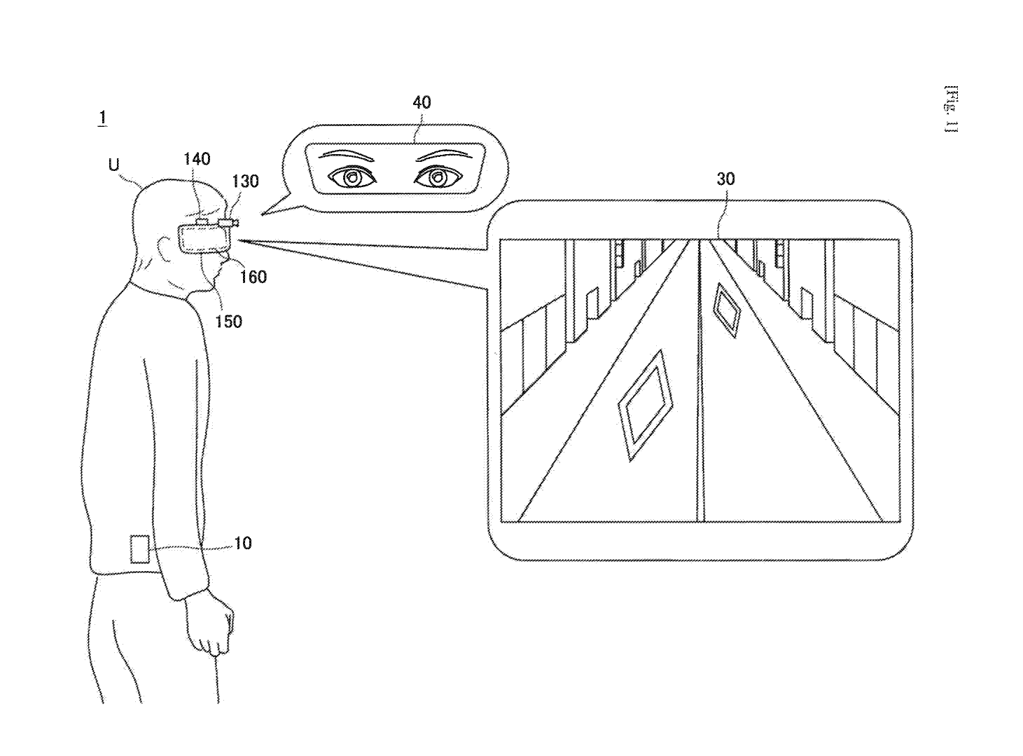

Firstly, a configuration example of an information processing system 1 according to an embodiment of the present disclosure will be described. FIG. 1 is a diagram illustrating a configuration example of the information processing system 1 according an embodiment of the present disclosure. As illustrated in FIG. 1, the information processing system 1 includes a display control device 10, an imaging unit 130, a sensor unit 140, a display unit 150, and a shading unit 160.

The imaging unit 130 has a function of capturing an imaging range. For example, the imaging unit 130 is mounted on a user's head so that the viewing direction of the user can be captured. A captured image 30 captured by the imaging unit 130 is provided to the display control device 10 by a wireless signal or a wired signal, for example. It is noted that in the example illustrated in FIG. 1, although the imaging unit 130 is configured separately from the display control device 10, the imaging unit 130 may be integrated with the display control device 10.

The sensor unit 140 detects sensor data, For example, the sensor unit 140 acquires an imaging result by capturing an eye area of a user U. Although the following description will mainly be based on a case in which both eye areas of the user U are captured by the sensor unit 140, the sensor unit 140 may he configured to capture only one of the eye areas of the user U. An imaging result 40 obtained by capturing with the sensor unit 140 is provided to the display control device 10 by a wireless signal or a wired signal, for example.

It is noted that in the present specification, although a case in which the eye areas of the user U are captured by the sensor unit 140 is mainly described, the sensor unit 140 may perform other measurements relating to the body of the user U. For example, the sensor unit 140 can measure the myoelectricity of the user U. In this case, the obtained myoelectric measurement result captured by the sensor unit 140 is provided to the display control device 10 by a wireless signal or a wired signal, for example.

Further, in the example illustrated in FIG. 1, although the sensor unit 140 is configured separately from the display control device 10, the sensor unit 140 may be integrated with the display control device 10. In addition, as described below, the information processing system 1 may have a sensor other than the sensor unit 140.

The display unit 150 has a function of displaying a virtual object based on a control signal provided from the display control device 10 by wireless signal or a wired signal. The type of virtual object displayed by the display unit 150 is not especially limited. Further, the present specification is mainly described based on a case in which the display unit 150 is a transmission-type HMD (head mounted display). It is noted that in the example illustrated in FIG. 1, although the display unit 150 is configured separately from the display control device 10, the display unit 150 may be integrated with the display control device 10.

The shading unit 160 has a function of adjusting amount of light that reaches the eye areas of the user U. The shading unit 160 may be configured so as to block only a part of the light that has passed through the display unit 150, to block all of the light, or to let all of the light through. In the example illustrated in FIG. 1, although the shading unit 160 is provided externally to the display unit 150, the position where the shading unit 160 is provided is not especially limited. The shading unit 160 may be configured from, for example, a liquid crystal shutter. It is noted that in the example illustrated in FIG. 1, although the shading unit 160 is configured separately from the display control device 10, the shading unit 160 may be integrated with the display control device 10.

A configuration example of the information processing system 1 according to an embodiment of the present disclosure was described above.

1-2. Function Configuration Example of Information Processing System

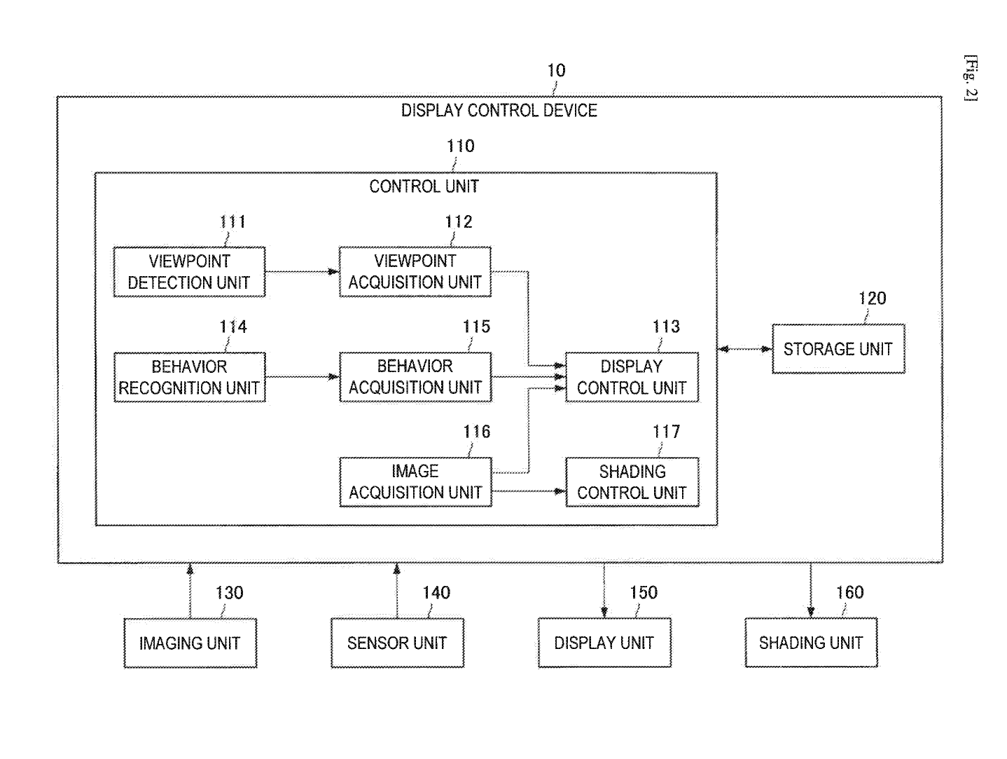

Next, a function configuration example of the information processing system 1 according to an embodiment of the present disclosure will be described. FIG. 2 is a diagram illustrating a function configuration example of the information processing system 1 according an embodiment of the present disclosure. As illustrated in FIG. 2, the display control device 10 according to an embodiment of the present disclosure includes a control unit 110 and a storage unit 120. As described above, the imaging unit 130, the sensor unit 140, the display unit 150, and the shading unit 160 are respectively connected to each other wirelessly or in a wired manner.

The control unit 110 corresponds to, for example, a CPU (central processing unit) or the like. The control unit 110 executes a program stored in the storage unit 120 or in another storage medium to realize the various functions that the control unit 110 has. The control unit 110 has a viewpoint detection unit 111, a viewpoint acquisition unit 112, a display control unit 113, a behavior recognition unit 114, a behavior acquisition unit 115, an image acquisition unit 116, and a shading control unit 117. The functions that these function blocks respectively have will be described below.

The storage unit 120 uses a storage medium, such as a semiconductor memory or a hard disk, to store programs for operating the control unit 110. Further, for example, the storage unit 120 can also store various kinds of data (e.g., an image for stereoscopic display of a virtual object etc.) that is used by the programs. It is noted that in the example illustrated in FIG. 2, although the storage unit 120 is configured separately from the display control device 10, the storage unit 120 may be integrated with the display control device 10.

A function configuration example of the information processing system 1 according to an embodiment of the present disclosure was described above.

1-3. Function Details of Display Control Device

Next, the function details of the display control device according to an embodiment of the present disclosure will be described. First, the display control unit 113 has a function of controlling the display unit 150 so that a virtual object is stereoscopically displayed by the display unit 150, and a function of controlling the position in the depth direction of the virtual object presented to the user. Accordingly, an example of a method for controlling the position in the depth direction of the virtual object presented to the user will be described.

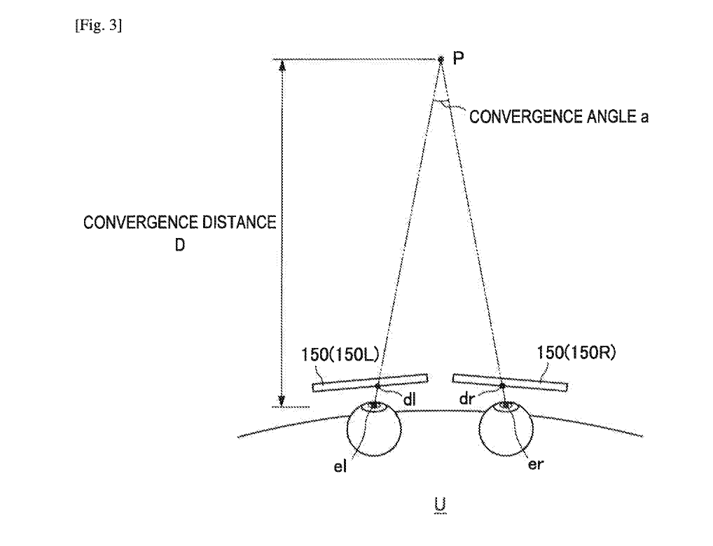

FIG. 3 is a diagram illustrating an example of a method for controlling the position in the depth direction of the virtual object presented to the user. The example illustrated in FIG. 3 includes a user's left eye position el and right eye position er. Here, if the display control unit 113 has displayed a left eye image presented to the left eye of the user at a display position dl of a display unit 150L, and aright eye image presented to the right eye of the user at a display position dr of a display unit 150R, the virtual object is stereoscopically displayed at a display position P. The display position P corresponds to the intersection of the straight line connecting the left eye position el and the display position dl with the straight line connecting the right eye position er and the display position dr.

In the example illustrated in FIG. 3, the distance from the display position P to the straight line connecting the left eye position el and the right eye position er is a convergence distance D, and the angle formed by the straight line connecting the left eye position el and the display position P and the straight line connecting the right eye position er and the display position P is a convergence angle a. The display control unit 113 can move the position in the depth direction of the virtual object presented to the user further away from the user by widening the gap between the display position dl and the display position dr the greater the convergence distance D is (or the smaller the convergence angle is).

On the other hand, the display control unit 113 can move the position in the depth direction of the virtual object presented to the user closer to the user by narrowing the gap between the display position dl and the display position dr the smaller the convergence distance D is (or the greater the convergence angle is). Thus, by controlling the display position dl of the left eye image and the display position dr of the right eye image, the display control unit 113 can control the position in the depth direction of the virtual object presented to the user. However, the method described here is merely an example. Therefore, the method for controlling the position in the depth direction of the virtual object presented to the user is not especially limited,

For example, the display control unit 113 can also control the position in the depth direction of the virtual object presented to the user by controlling the size of the virtual object utilizing the characteristic that the larger the size of a virtual object, the closer it looks. Further, the display control unit 113 can also control the position in the depth direction of the virtual object presented to the user by controlling the position where the virtual object is in focus. In addition, the display control unit 113 can also control the position in the depth direction of the virtual object presented to the user by controlling the magnitude of parallax.

An example of the method for controlling the position in the depth direction of the virtual object presented to the user was described above. Here, if a deviation occurs between the position in the depth direction of the virtual object and the user's viewpoint, a situation can occur it: which it is more difficult to view the virtual object. Consequently, the present specification proposes a technology that enables a virtual object to be stereoscopically displayed so that it is easier for the user to view.

The viewpoint detection unit 111 detects the user's viewpoint based on sensor data detected by the sensor unit 140. For example, the viewpoint detection unit 111 detects the user's viewpoint based on an imaging result 40 captured by the sensor unit 140. The method for detecting the viewpoint with the viewpoint detection unit 111 may employ the technology disclosed in JP 2012-8746A, for example. However, the method for detecting the viewpoint with the viewpoint detection unit 111 is not especially limited.

For example, the sensor unit 140 can also detect the user's viewpoint based on a myoelectricity measurement result by the sensor unit 140. In the example illustrated in FIG. 2, although the viewpoint detection unit 111 is included in the display control device 10, the viewpoint detection unit may be included in the sensor unit 140 instead of the display control device 10. The user's viewpoint detected by the viewpoint detection unit 111 is acquired by the viewpoint acquisition unit 112.

The behavior recognition unit 114 recognizes a user behavior. The method for recognizing the user behavior may employ the technology disclosed in JP 2006-345269A, for example. According to this technology, for example, a user behavior is recognized by detecting a movement made by the user with a sensor, and analyzing the detected movement with the behavior recognition unit 114.

However, the method for recognizing a behavior with the behavior recognition unit 114 is not especially limited to this example. For example, if a behavior input from the user has been received, the behavior recognition unit 114 can acquire the behavior for which the input from the user was received. In the example illustrated in FIG. 2, although the behavior recognition unit 114 is included in the display control device 10, the behavior recognition unit 114 may be included in the sensor unit 140 instead of the display control device 10. The user behavior recognized by the behavior recognition unit 114 is acquired by the behavior acquisition unit 115.

Next, the display control unit 113 controls the position in the depth direction of the virtual object presented to the user based on the viewpoint acquired by the viewpoint acquisition unit 112. This control allows the position in the depth direction of the virtual object presented to the user to be controlled based on the distance to the user's viewpoint, so that a stereoscopic display of the virtual object can be displayed to make it easier for the user to view.

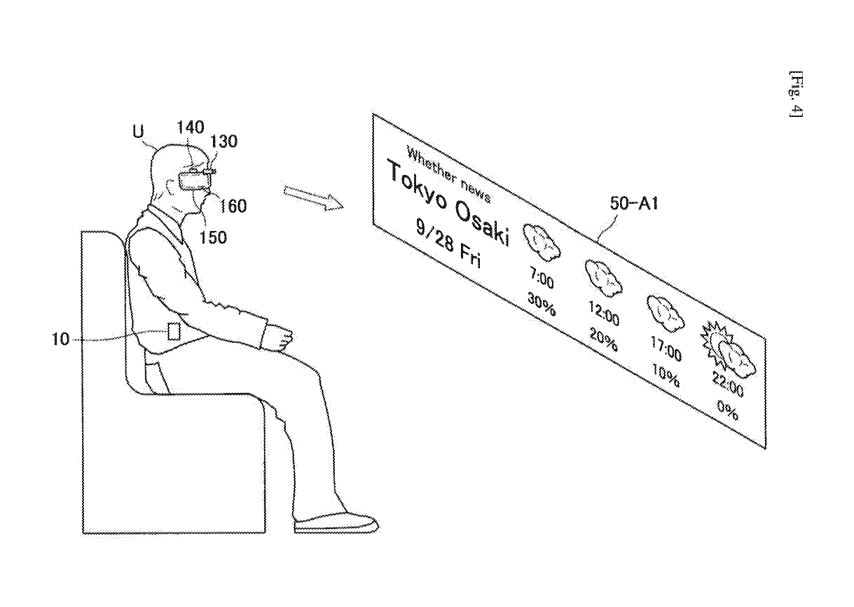

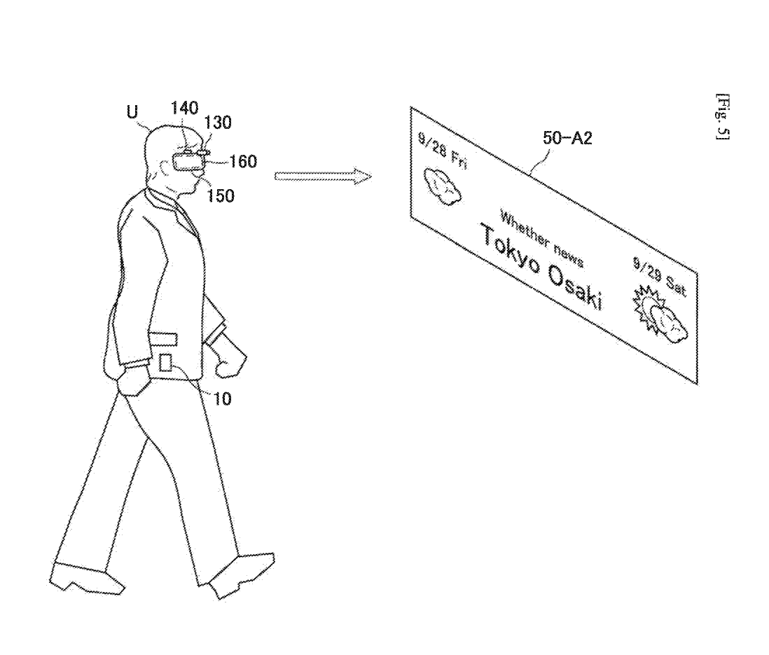

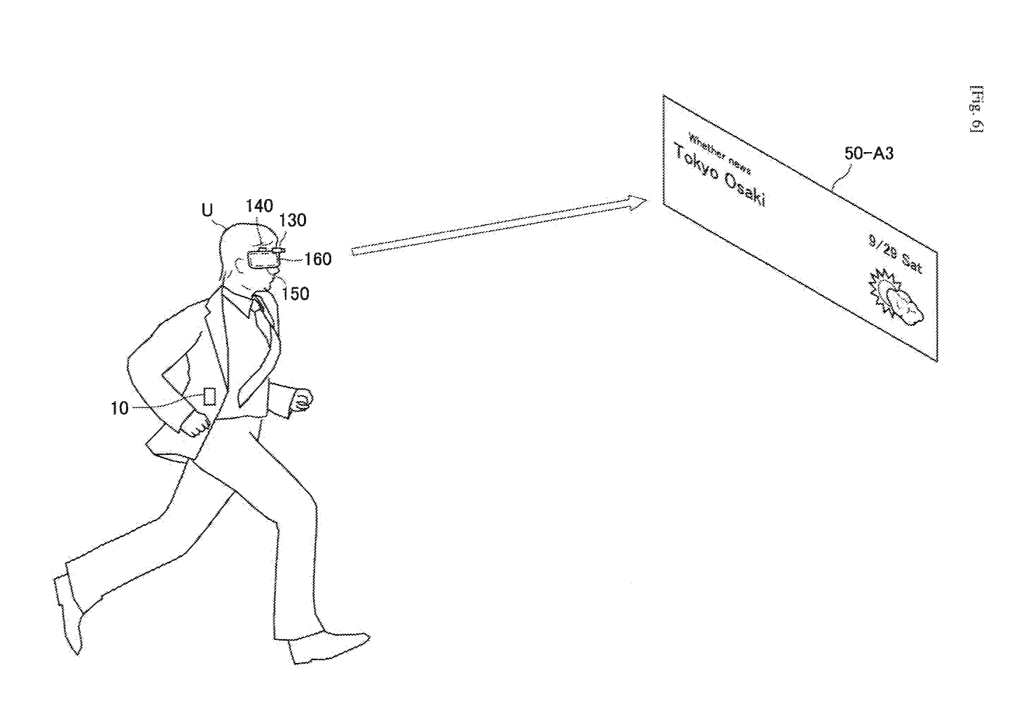

Examples of the method for controlling the position in the depth direction of the virtual object presented to the user will now be described in more detail. First, an example in which the virtual object is a weather forecast screen will be described with reference to FIGS. 4 to 7. However, since the fact that the kind of virtual object is not especially limited is as described above, the virtual object is obviously not limited to a weather forecast screen.

FIGS. 4 to 6 are diagrams illustrating examples of presentation of weather forecast screens 50-A1 to 50-A3 to the user when the user is stationary, walking, and running, respectively. As illustrated in FIGS. 4 to 6, the user's viewpoint is further away when walking than when stationary, and is further away when running than when walking. Therefore, for example, the display control unit 113 can move the position in the depth direction of the virtual object presented to the user further away the more hither away the viewpoint is from the user.

It is noted that there may also be cases in which the viewpoint has merely temporarily changed. If the position in the depth direction of the virtual object presented to the user is changed every time the distance to the user's viewpoint changes even in such cases, a greater burden may be placed on the user. Therefore, the display control unit 113 can also be configured to control the position in the depth direction of the virtual Object presented to the user in cases when the viewpoint has not changed even after a predetermined duration has elapsed.

Further, content (e.g., character data, image data etc.) is included on each of the weather forecast screens 50-A1 to 50-A3. Although the content may be fixed irrespective of the user behavior, the content. can also be changed based on the user behavior. For example, the display control unit 113 can control the content included on the weather forecast screens based on the behavior acquired by the behavior acquisition unit 115.

The control of the content included on the weather forecast screens can be carried out in any manner. For instance, the display control unit 113 can control the amount of content information included in the virtual object. For example, as illustrated in FIGS. 4 to 6, a situation can occur in which the content is not as easy to view when walking as when stationary. Accordingly, the display control unit 113 can control so that the amount of content information included on a weather forecast screen presented to the user is smaller the greater the movement speed of a behavior is.

Further, the display control unit 113 can also control the display size of the content included in the virtual object based on a user behavior. For example, as described above, a situation can occur in which the content is not as easy to view when walking as when stationary. In addition, a situation can occur in which the content is not as easy to view when running as when walking. Accordingly, the display control unit 113 can control no that the display size of the content included on a weather forecast screen presented to the user is larger the greater the movement speed of a behavior is.

Still further, the display control unit 113 cart also control the position in the virtual object of the content included in the virtual object based on a user behavior. For example, as described above, a situation can occur in which the content is not as easy to view when walking as when stationary. In addition, a situation can occur in which the content is not as easy to view when running as when walking. Accordingly, the display control unit 113 can control so that the position in the virtual object of the content included on a weather forecast screen presented to the user is concentrated at the edge portions of the virtual object the greater the movement speed of a behavior is.

The weather forecast screen corresponding to a user behavior may be created in advance, or may be created each time a screen is displayed. For example, if the weather forecast screen is created in advance, the display control unit 113 can he configured to present to the user a weather forecast screen corresponding to the user behavior. Further, the display control unit 113 can also be configured to create a weather forecast screen based on the amount of information about the content corresponding to the user behavior.

Similarly, the display control unit 113 can also create the weather forecast screen based on the display size of the content corresponding to the user behavior. Further, the display control unit 113 can create the weather forecast screen based on the position in the virtual object of the content.

It is noted that the display control unit 113 can control the position in the depth direction of the virtual object presented to the user based on a user behavior. For example, the display control unit 113 can control so that the position in the depth direction of the virtual object presented to the user is more further away the greater the movement speed indicated by the behavior is.

Further, although the display control unit 113 can control the position in the depth direction of the virtual object presented to the user based on either a behavior or the viewpoint of the user, the display control unit 113 can also control the position in the depth direction of the virtual object presented to the user based on both the behavior and the viewpoint of the user. Alternatively, the display control unit 113 can determine whether to preferentially use the behavior or the viewpoint of the user based on the situation.

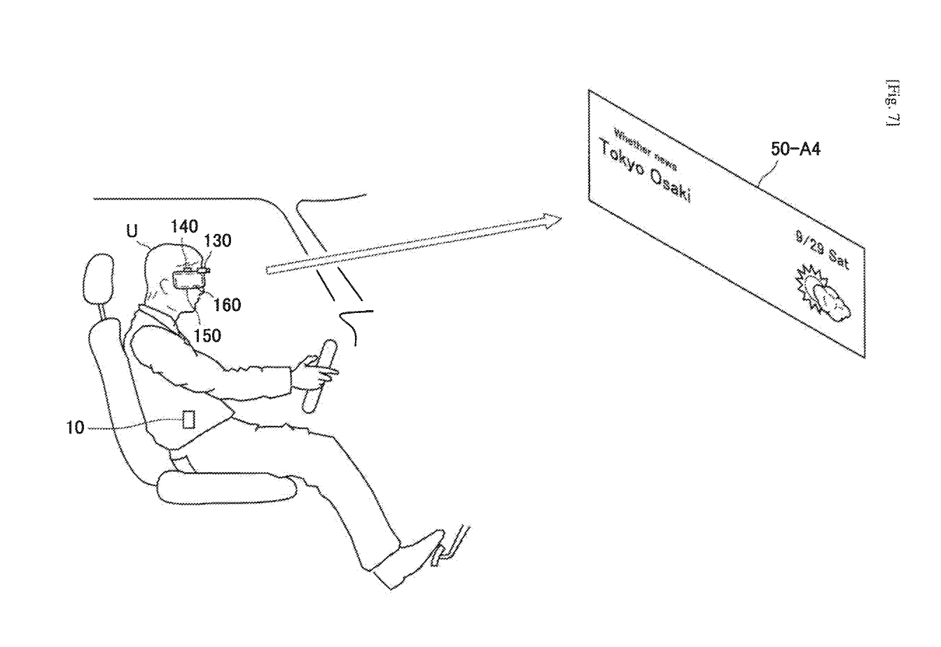

FIG. 7 is a diagram illustrating an example of presentation of a weather forecast screen 50-A4 to the user when driving. As illustrated in FIG. 7, when the user is driving a vehicle, although his/her behavior is “stationary”, his/her viewpoint is often far away. Consequently, the display control unit 113 can control the position in the depth direction of the weather forecast screen 50-A4 presented to the user based on the viewpoint by preferentially utilizing viewpoint over behavior.

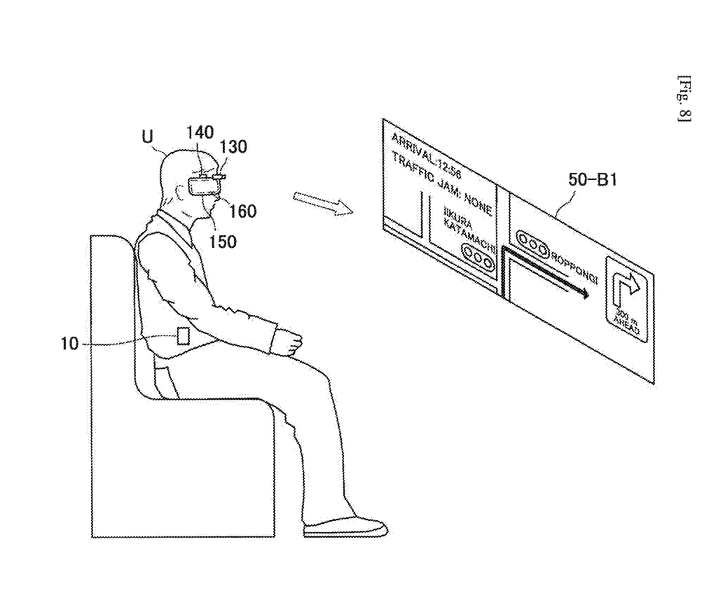

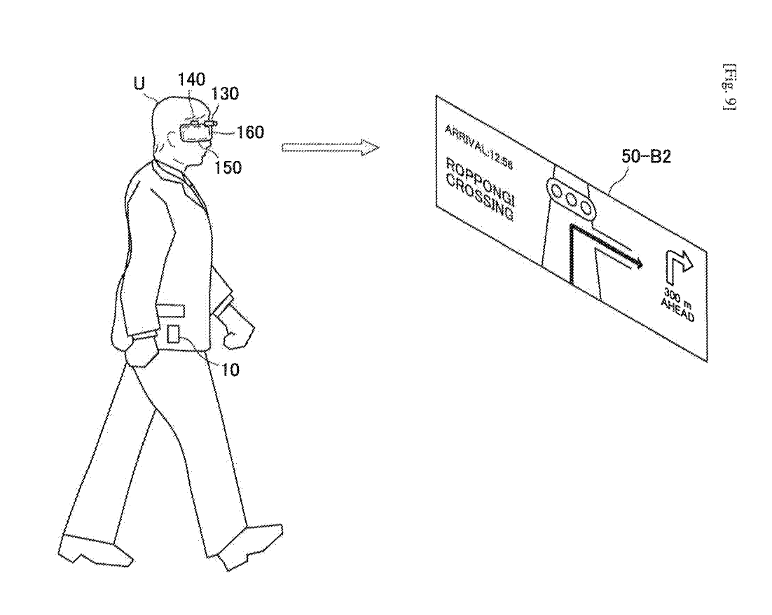

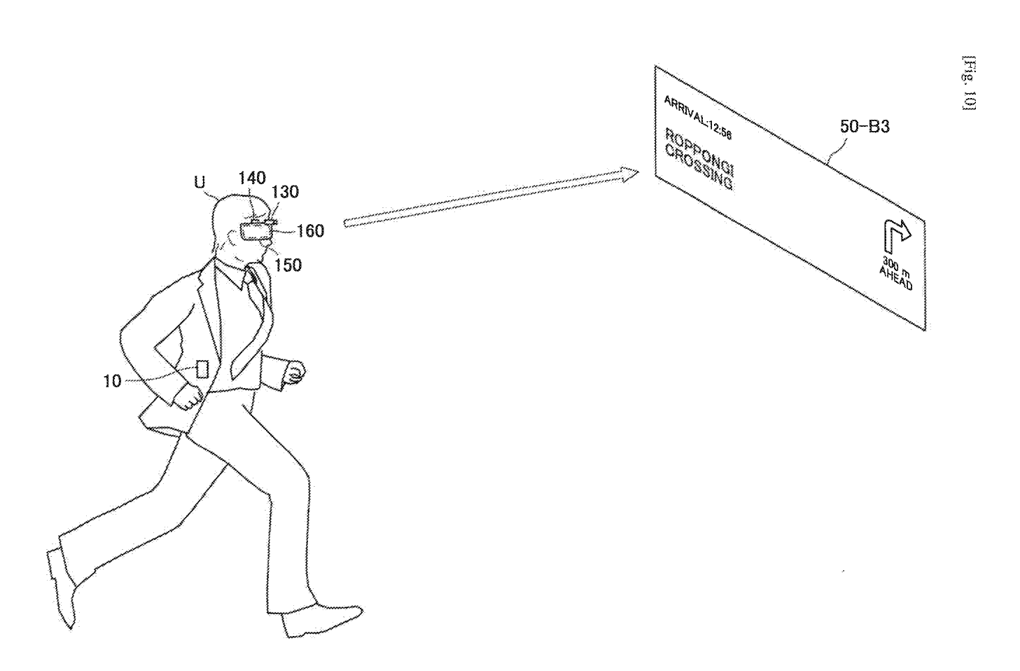

FIGS. 8 to 10 are diagrams illustrating examples of presentation of navigation screens 50-B1 to 50-B3 to the user when the user is stationary, walking, and running, respectively. As illustrated in FIGS. 8 to 10, even if the virtual object is a navigation screen, the position in the depth direction of the virtual object presented to the user can be controlled in the same manner as when the virtual object is a weather forecast screen. Obviously, the virtual object is not limited to being a navigation screen.

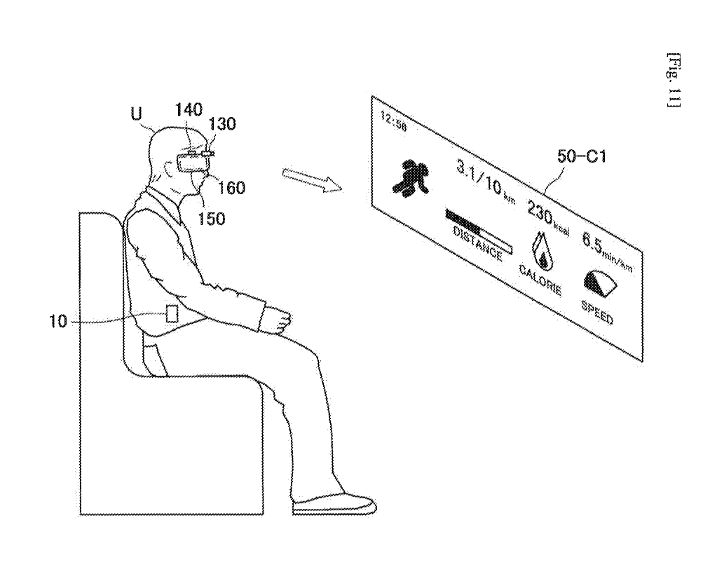

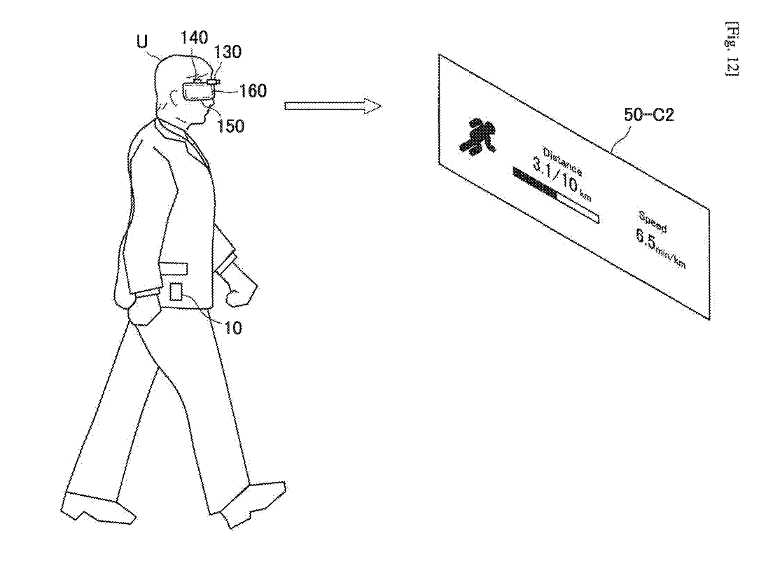

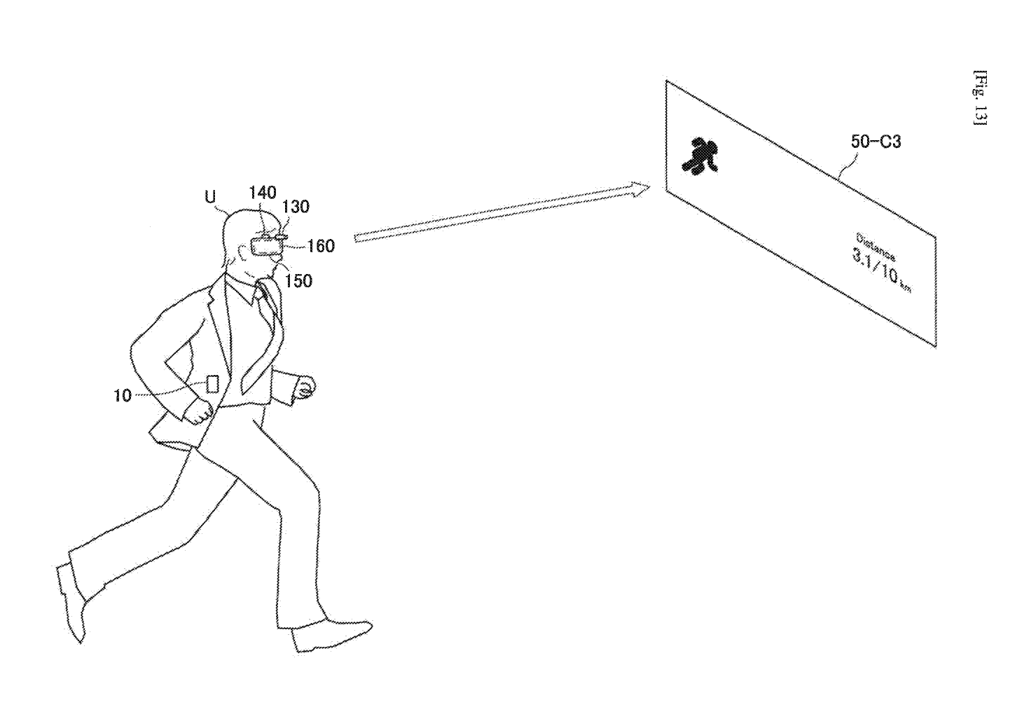

Further, FIGS. 11 to 13 are diagrams illustrating examples of presentation of running application screens 50-C1 to 50-C3 to the user when the user is stationary, walking, and running, respectively. As illustrated in FIGS. 11 to 13, even if the virtual object is a running application screen, the position in the depth direction of the virtual object presented to the user can be controlled in the same manner as when the virtual object is a weather forecast screen. Obviously, the virtual object is not limited to being a running application screen.

In the above-described examples, although methods for controlling a virtual object based on the viewpoint or a behavior of the user himself/herself were described, the virtual object can also be controlled based on various other factors. As an example, the image acquisition unit 116 can acquire a captured image 30 captured by the imaging unit 130, and the display control unit 113 can control the virtual object based on the captured image 30 acquired by the image acquisition unit 116. This control enables a virtual object to be controlled based on the environment surrounding the user.

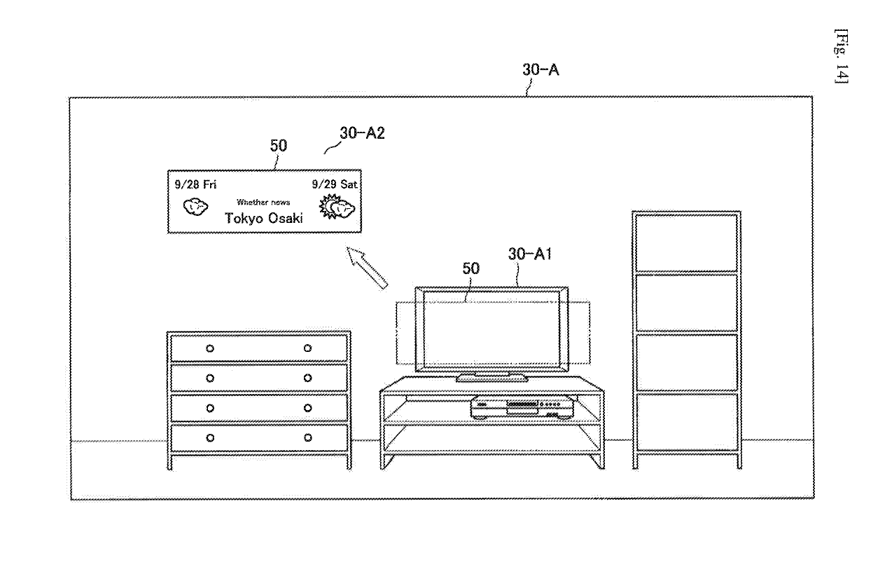

The method for controlling the virtual object based on the captured image 30 is not especially limited. For example, the display control unit 113 can control the display position of the virtual object based on luminance information about the captured image 30. FIG. 14 is a diagram illustrating an example of controlling a display position of a virtual object 50 based on luminance information about the captured image 30. As illustrated in FIG. 14, a captured image 30-A includes an area 30-A1 and an area 30-A2.

Here, consider, for example, a case in which when the display control unit 113 tries to display the virtual object 50 on the area 30-A1, the display control unit 113 detects that the luminance of area 30-A1 is higher than a threshold. However, the display control unit 113 also detects that the luminance of the area 30-A2 is less than the threshold. In such a case, the display control unit 113 can change the display position of the virtual object 50 to area 30-A2. This change enables a virtual object 50 that can be easily viewed by the user to be presented.

It is noted that although an example was described in which the display position of the virtual object 50 is controlled by the display control unit 113, the display control unit 113 can control the luminance of the virtual object based on luminance information about the captured image 30. For example, in the example illustrated in FIG. 14, instead of changing the display position of the virtual object 50 to the area 30-A2, the display control unit 113 can increase the luminance of the virtual object 50. This change also enables a virtual object 50 that can be easily viewed by the user to be presented.

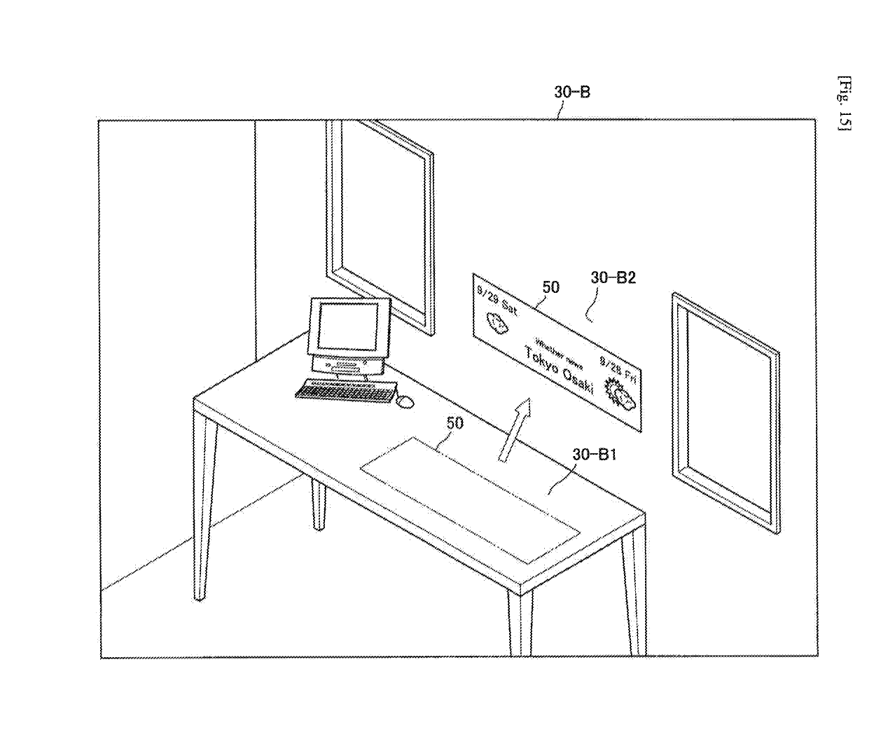

Further, the display control unit 113 can also control the display position of the virtual object based on color information about the captured image 30. FIG. 15 is a diagram illustrating an example of controlling the display position of the virtual object 50 based on color information about the captured image 30. As illustrated in FIG. 15, a captured image 30-B includes an area 30-B1 and an area 30-B2.

Here, consider, for example, a case in which when the display control unit 113 tries to display the virtual object 50 on the area 30-B1, the display control unit 113 detects that the area 30-B1 and the virtual object 50 are similar colors. However, the display control unit 113 also detects that the area 30-B2 and the virtual object 50 are not similar colors. In such a case, the display control unit 113 can change the display position of the virtual object 50 to area 30-B2. This change enables a virtual object 50 that can be easily viewed by the user to be presented.

For example, if the distance between the color of the area 30-B2 and the color of the virtual object 50 is less than a threshold, the display control unit 113 detects that the area 30-B1 and the virtual object 50 are similar colors. The distance between the color of the area 30-B2 and the color of the virtual object 50 can be calculated based on a three-dimensional distance between two points when the R value, the G value, and the B value of the area 30-B2 are plotted on the X axis, the Y axis, and the Z axis, and the R value, the G value, and the B value of the virtual object 50 are plotted on the X axis, the Y axis, and the Z axis.

It is noted that although an example was described in which the display position of the virtual object 50 is controlled by the display control unit 113, the display control unit 113 can control the color of the virtual object based on color information about the captured image 30. For example, in the example illustrated in FIG. 15, instead of changing the display position of the virtual object 50 to the area 30-B2, the display control unit 113 can change the color of the virtual object 50. The display control unit 113 can also change the color of the virtual object 50 to a complementary color of the color of the area 30-B2. This change also enables a virtual object 50 that can be easily viewed by the user to be presented.

Further, for example, the display control unit 113 can also control the display position of the virtual object 50 based on a feature amount extracted from the captured. image 30. Referring again to FIG. 14, when the display control unit. 113 tries to display the virtual object 50 on the area 30-A1, since in area 30-A1 there is an object in front of the wall, the display control unit 113 detects that a degree of stability of the feature amount extracted from the area 30-A1 is smaller than a threshold. On the other hand, since there are no objects in front of the wall in area 30-A2, the display control unit 113 detects that the degree of stability of the feature amount extracted from the area 30-A2 is greater than the threshold.

In such a case, the display control unit 113 can change the display position of the virtual object 50 to the area 30-A2. This change enables a virtual object 50 that can be easily viewed by the user to be presented. The method for calculating the degree of stability of the feature amount in each area is not especially limited. For example, the display control unit 113 can calculate that the degree of stability is higher the smaller the difference between a maximum value. and a minimum value of the feature amount in each area is.

Further, for example, if an object was detected from the captured image 30, the display control unit 113 can also control the display position of the virtual object 50 presented to the user based on the position of the object. An example will now be described again with reference to FIG. 14, in which a wall is used as an example of the object. Here, when the display control unit 113 tries to display the virtual object 50, the display control unit 113 recognizes that a wall is shown in area 30-A2. In this case, the display control unit 113 can display the virtual object 50 on the area 30-A2 where it was recognized that a wall is shown.

In addition, the display control unit 113 can also control the position in the depth direction of the virtual object 50. For example, the display control unit 113 can measure the distance from the imaging unit 130 to a target that is in focus as the position in the depth direction of the wall, and adjust so that the position in the depth direction of the virtual object 50 matches the position in the depth direction of the wall. This enables the virtual object 50 to be presented more naturally, since the position in the depth direction of the virtual object 50 is also adjusted based on the position in the depth direction of the object.

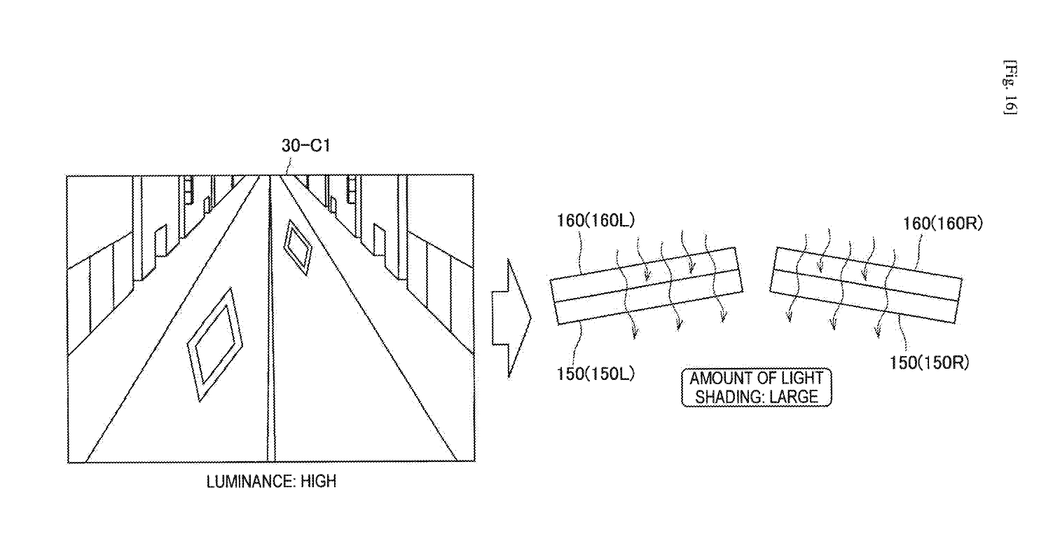

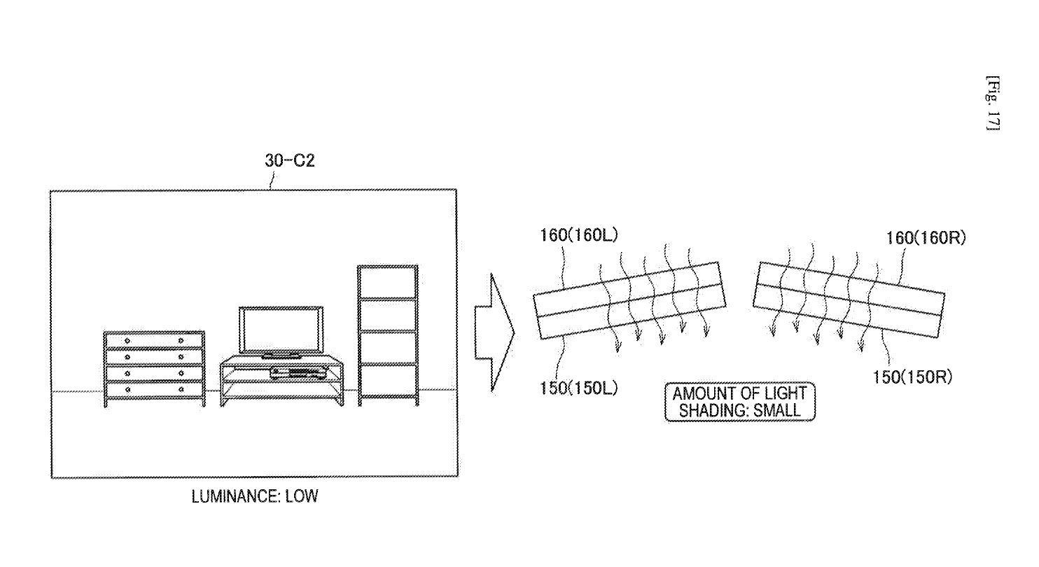

Here, as described above, the information processing system 1 includes the shading unit 160, which adjusts the amount of light reaching the eye areas of the user U. The shading amount by the shading unit 160 may be fixed, or can be controlled based on the situation. For example, the shading control unit 117 can control the shading amount by the shading unit 160 based on luminance information about the captured image 30. FIGS. 16 and 17 are diagrams illustrating examples of controlling the shading amount based on luminance information about the captured image 30.

In the example illustrated in FIG. 16, a captured image 30-C1 is acquired by the image acquisition unit 116. Here, since the captured image 30-C1 was captured at a bright location, the luminance is high. In such a case, the shading control unit 117 can control the shading unit 160 (the shading unit 160L and shading unit 160R) so that the shading amount is larger.

On the other hand, in the example illustrated in FIG. 17, a captured image 30-C2 is acquired by the image acquisition unit 116. Here, since the captured image 30-C2 was captured at a dark location, the luminance is low. In such a case, the shading control unit 117 can control the shading unit 160 (the shading unit 160L and shading unit 160R) so that the shading amount is smaller.

Thus, the shading control unit 117 can control the shading unit 160 so that the shading amount by the shading unit 160 is larger the higher the luminance of the captured image 30 is. This control enables the amount of tight that is incident on the user's eyes to be reduced when the user's field of view is brighter, which should make it even easier for the user to view the virtual object 50.

The function details of the display control device 10 according to an embodiment of the present disclosure were described above.

1-4. Display Control Device Operations

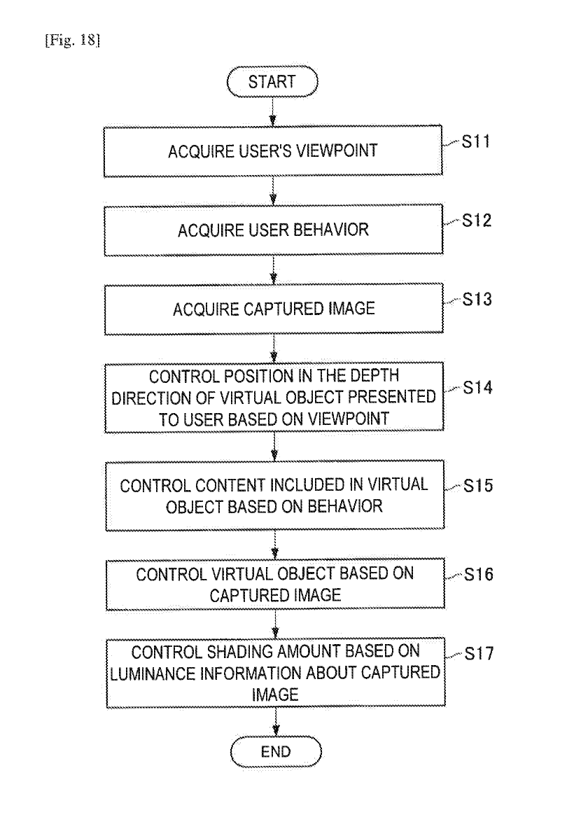

Next, a flow of the operations in the display control device 10 according to an embodiment of the present disclosure will be described. FIG. 18 is a flowchart illustrating a flow of operations in the display control device 10 according to an embodiment of the present disclosure. It is noted that the example illustrated in FIG. 18 is merely an example of the flow of operations in the display control device 10 according to an embodiment of the present disclosure. Therefore, the flow of operations in the display control device 10 according to an embodiment of the present disclosure is not limited to the example illustrated in FIG. 18.

As illustrated in FIG. 18, first, the viewpoint acquisition unit 112 acquires a user's viewpoint detected by the viewpoint detection unit 111 (S11), and the behavior acquisition unit 115 acquires a user behavior recognized by the behavior recognition unit 114 (S12). Further, the image acquisition unit 116 acquires a captured image captured by the imaging unit 130 (S13). The display control unit 113 controls the position in the depth direction of the virtual object presented to the user based on the viewpoint acquired by the viewpoint acquisition unit 112 (S14).

Further, the display control unit 113 controls the content included in the virtual object based on the behavior acquired by the behavior acquisition unit 115 (S15). In addition, the display control unit 113 controls the virtual object based on the captured image captured by the imaging unit 130 (S16). The shading control unit 117 controls the shading amount by the shading unit 160 based on luminance information about the captured image (S17). After the operation of S17 has finished, the control unit 110 can return to the operation of S11, or finish operations.

The flow of operations in the display control device 10 according to an embodiment of the present disclosure was described above.

1-5. Hardware Configuration Example

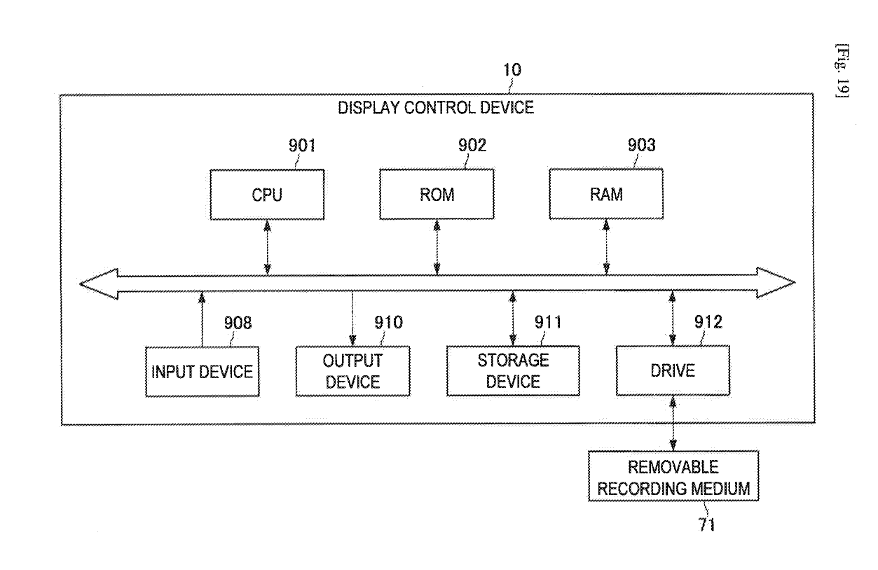

Next, a hardware configuration example of the display control device 10 according to an embodiment of the present disclosure be described. FIG. 19 is a diagram illustrating an example of the hardware configuration of the display control device 10 according to an embodiment of the present disclosure. The hardware configuration example illustrated in FIG. 19 is merely an example of the hardware configuration example of the display control device 10. Therefore, the hardware configuration example of the display control device 10 is not limited to the example illustrated in FIG. 19.

As illustrated in FIG. 19, the display control device 10 includes a CPU (central processing unit) 901, a ROM (read-only memory) 902, a RAM (random-access memory) 903, an input device 908, an output device 910, a storage device 911, and a drive 912.

The CPU 901, which functions as a calculation processing device and a control device, controls the overall operation of the display control device 10 based on various programs. Further, the CPU 901 may be a microprocessor. The ROM 902 stores programs, calculation parameters and the like used by the CPU 901. The RAM 903 temporarily stores the programs to be used during execution by the CPU 901, and parameters that appropriately change during that execution. These units are connected to each other by a host bus, which is configured from a CPU bus or the like.

The input device 908 receives sensor data measured by the sensor unit 140 (e.g., an imaging result captured by the sensor unit 140) and input of a captured image captured by the imaging unit 130. The sensor data and the captured image whose input was received by the input device 908 are output to the CPU 901. Further, the input device 908 can also output to the CPU 901 a detection result detected by another sensor.

The output device 910 provides output data to the display unit 150. For example, the output device 910 provides display data to the display unit 150 under the control of the CPU 901. If the display unit 150 is configured from an audio output device, the output device 910 provides audio data to the display unit 150 under the control of the CPU 901.

The storage device 911 is a device used to store data that is configured as an example of the storage unit 120 in the display control device 10. The storage device 911 may also include a storage medium, a recording device that records data on the storage medium, a reading device that reads data from the storage medium, a deletion device that deletes data recorded on the storage medium and the like. This storage device 911 stores programs executed by the CPU 901 and various kinds of data.

The drive 912 is a storage medium reader/writer, which may be built-in or externally attached to the display control device 10. The drive 912 reads information recorded on a removable storage medium 71, such as a mounted magnetic disk, optical disc, magneto-optical disk, or semiconductor memory, and outputs the read information to the RAM 903. Further, the drive 912 can also write information to the removable storage medium 71.

A hardware configuration example of the display control device 10 according to an embodiment of the present disclosure was described above.

<2. Summary>

As described above, according to an embodiment of the present disclosure, a display control device 10 is provided that includes a viewpoint acquisition unit 112, which acquires a user's viewpoint detected by a viewpoint detection unit 111, and a display control unit 113, which controls a display unit 150 so that a virtual object 50 is stereoscopically displayed by the display unit 150, in which the display control unit 113 controls the position in the depth direction of the virtual object 50 presented to the user based on the viewpoint. According to this configuration, the virtual object can be stereoscopically displayed so that it is easier for the user to view.

It should be understood by those skilled in the art that various modifications, combinations, sub-combinations and alterations may occur depending on design requirements and other factors insofar as they are within the scope of the appended claims or the equivalents thereof.

Further, a program for realizing the same functions as the units included in the above-described display control device 10 can also recreate the hardware, such as the CPU, the ROM, and the RAM, that is included in the computer. In addition, a non-transitory computer-readable recording medium having this program recorded thereon can also be provided.

Additionally, the present technology may also be configured as below.

(1) A display control device comprising: an acquisition unit configured to acquire a behavior of a user; and a display control unit configured to control a display unit to display a virtual object at a display position having a depth that is perceivable by a user, the display position being determined based upon the acquired behavior of the user, wherein at least one of the acquisition unit and the display control unit is implemented via one or more processors.

(2) The display control device according to (1), wherein the display control device further comprises the display unit.

(3) The display control device according to (1), wherein the display control unit is further configured to control an amount of content information included in the virtual object based on the behavior.

(4) The display control device according to (1), wherein the display control unit is further configured to control a display size of a content included in the virtual object based on the behavior.

(5) The display control device according to (1), wherein the display control unit is further configured to control a position in the virtual object of a content included in the virtual object based on the behavior.

(6) The display control device according to claim (1), wherein the display control unit is further configured to control a location of the display position in a depth direction of the virtual object presented to the user based on the behavior.

(7) The display control device according to (1), further comprising: an image acquisition unit configured to acquire a captured image captured by an imaging unit, wherein the display control unit is further configured to control the display of the virtual object based on the captured image.

(8) The display control device according to (7), wherein the display control unit is further configured to control a location of the display position of the virtual object based on luminance information about the captured image.

(9) The display control device according to (7), wherein the display control unit is further configured to control a luminance of the displayed virtual object based on luminance information about the captured image.

(10) The display control device according to (7), wherein the display control unit is further configured to control a location of the display position of the virtual object based on color information about the captured image.

(11) The display control device according to (7), wherein the display control unit is further configured to control a color of the displayed virtual object based on color information about the captured image.

(12) The display control device according to (7), wherein the display control unit is further configured to control a location of the display position of the virtual object based on a feature amount extracted from the captured image.

(13) The display control device according to (1), further comprising: an image acquisition unit configured to acquire a captured image captured by an imaging unit; and a shading control unit configured to control a shading amount of the displayed virtual object based on luminance information about the captured image.

(14) The display control device according to (1), wherein the display control unit is further configured to control a location of the display position in a depth direction of the virtual object presented to the user by controlling a position of display of a left eye image presented to a left eye of the user and a position of display of a right eye image presented to a right eye of the user.

(15) The display control device according to (1), further comprising: an image acquisition unit configured to acquire a captured image captured by an imaging unit, wherein the display control unit is further configured to, when an object has been detected from the captured image, control a location of the display position of the virtual object presented to the user based on a position of the detected object.

(16) The display control device according to (1), further comprising: a viewpoint acquisition unit configured to acquire a viewpoint of the user detected by a viewpoint detection unit, wherein the display control unit is further configured to move a location of the display position in a depth direction of the virtual object presented to the user further away, the further the detected viewpoint is from the user.

(17) The display control device according to (16), wherein the acquired viewpoint is located in a direction of a gaze of the user and corresponds to a depth of the gaze.

(18) The display control device according to (1), further comprising: a viewpoint acquisition unit configured to acquire a viewpoint of the user detected by a viewpoint detection unit, wherein the display position of the virtual object is further being determined based upon the acquired viewpoint of the user.

(19) The display control device according to (1), wherein at least one of a size and an orientation of the displayed virtual object is determined based on the acquired behavior of the user.

(20) The display control device according to (1), wherein the display control unit is further configured to control the display unit to stereoscopically display the virtual object.

(21) The display control device according to (1), wherein the display control unit is configured to control the display unit to display, in correlation with a higher detected movement speed of the acquired behavior, at least one of a smaller amount of displayed content of the virtual object, a larger display size of the displayed content of the virtual object, and a display of the content of the virtual object to be more towards an edge portion of the virtual object.

(22) The display control device according to (1), wherein the display position corresponds to a real world location and the virtual object is provided to be superimposed within the user's perceived view of the real world, the display position being determined based upon the acquired behavior of the user.

(23) The display control device according to (1), further comprising: a sensor unit configured to obtain sensor data pertaining to the user.

(24) The display control device according to (1), further comprising: an imaging unit configured to capture an image in a viewing direction of the user.

(25) A display control method comprising: acquiring a behavior of a user; controlling a display unit to display a virtual object; and controlling the display unit to display the virtual object at a display position having a depth that is perceivable by a user, the display position being determined based upon the acquired behavior of the user.

(26) A non-transitory computer-readable recording medium having embodied thereon a program, which when executed by a computer causes the computer to perform a display control method, the method comprising: acquiring a behavior of a user; controlling a display unit to display a virtual object; and controlling the display unit to display the virtual object at a display position having a depth that is perceivable by a user, the display position being determined based upon the acquired behavior of the user.

(27) A display control device including:
a viewpoint acquisition unit configured to acquire a viewpoint of a user detected by a viewpoint detection unit; and
a display control unit configured to control a display unit on that a virtual object is stereoscopically displayed by the display unit,
wherein the display control unit is configured to control a position in a depth direction of the virtual object presented to the user based on the viewpoint.

(28) The display control device according to (27), further including:
a behavior acquisition unit configured to acquire a user behavior recognized by a behavior recognition unit,
wherein the display control unit is configured to control content included in the virtual object based on the behavior.

(29) The display control device according to (28), wherein the display control unit is configured to control an amount of content information included in the virtual object based on the behavior.

(30) The display control device according to (28), wherein the display control unit is configured to control a display size of content included in the virtual object based on the behavior.

(31) The display control device according to (28), wherein the display control unit is configured to control a position in the virtual object of content included in the virtual object based on the behavior.

(32) The display control device according to (27), further including:
a behavior acquisition unit configured to acquire a user behavior recognized by a behavior recognition unit,
wherein the display control unit is configured to control a position in a depth direction of the virtual object presented to the user based on the behavior,

(33) The display control device according to any one of (27) to (32), further including: an image acquisition unit configured to acquire a captured image captured by an imaging unit,
wherein the display control unit is configured to control the virtual object based on the captured image.

(34) The display control device according to (33), wherein the display control unit is configured to control a display position of the virtual object based on luminance information about the captured image.

(35) The display control device according to (33), wherein the display control unit is configured to control a luminance of the virtual object based on luminance information about the captured image.

(36) The display control device according to (33), wherein the display control unit is configured to control a display position of the virtual object based on color information about the captured image.

(37) The display control device according to (33), wherein the display control unit is configured to control a color of the virtual object. based on color information about the captured image

(38) The display control device according to (33), wherein the display control unit is configured to control a display position of the virtual object based on a feature amount extracted from the captured image.

(39) The display control device according to any one of (27) to (38), further including:
an image acquisition unit configured to acquire a captured image captured by an imaging unit; and
a shading control unit configured to control a shading amount with a shading unit based on luminance information about the captured image.

(40) The display control device according to any one of (27) to (39), wherein the display control unit is configured to control a position in a depth direction of a virtual object presented to the user by controlling a display position of a left eye image presented to a left eye of the user and a display position of a right eye image presented to a right eye of the user.

(41) The display control device according to any one of (27) to (40), further including:
an image acquisition unit configured to acquire a captured image captured by an imaging unit,
wherein the display control unit is configured to, when an object has been detected from the captured image, control a position of the virtual object presented to the user based on a position of the object.

(42) The display control device according to any one of (27) to (41), wherein the display control unit is configured to move a position in a depth direction of the virtual object presented to the user further away the more further away the viewpoint is from the user.

(43) A display control method including:
acquiring a viewpoint of a user detected by a viewpoint detection unit;
controlling a display unit so that a virtual object is stereoscopically displayed by the display unit; and
controlling a position in a depth direction of the virtual object presented to the user based on the viewpoint.

(44) A non-transitory computer-readable recording medium having a program recorded thereon that causes a computer to function as a display control device, the display control device including:
a viewpoint acquisition unit configured to acquire a viewpoint of a user detected by a viewpoint detection unit; and
a display control unit configured to control a display unit so that a virtual object is stereoscopically displayed by the display unit,
wherein the display control unit is configured to control a position in a depth direction of the virtual object presented to the user based on the viewpoint.

### REFERENCE SIGNS LIST

1 information processing system

10 display control device

30 captured image

40 imaging result

50 virtual object

110 control unit

111 viewpoint detection unit

112 viewpoint acquisition unit

113 display control unit

114 behavior recognition unit

115 behavior acquisition unit

116 image acquisition unit

117 shading control unit

120 storage unit

130 imaging unit

140 sensor unit

150 (150L, 150R) display unit

160 (160L, 160R) shading unit

1. A display control device comprising:
an acquisition unit configured to acquire a behavior of a user; and
a display control unit configured to control a display unit to display a virtual object at a display position having a depth that is perceivable by a user, the display position being determined based upon the acquired behavior of the user,
wherein at least one of the acquisition unit and the display control unit is implemented via one or more processors.

2. The display control device according to claim 1,
wherein the display control device further comprises the display unit.

3. The display control device according to claim 1, wherein the display control unit is further configured to control an amount of content information included in the virtual object based on the behavior.

4. The display control device according to claim 1, wherein the display control unit is further configured to control a display size of a content included in the virtual object based on the behavior.

5. The display control device according to claim 1, wherein the display control unit is further configured to control a position in the virtual object of a content included in the virtual object based on the behavior.

6. The display control device according to claim 1, wherein the display control unit is further configured to control a location of the display position in a depth direction of the virtual object presented to the user based on the behavior.

7. The display control device according to claim 1, further comprising:
an image acquisition unit configured to acquire a captured image captured by an imaging unit,
wherein the display control unit is further configured to control the display of the virtual object based on the captured image.

8. The display control device according to claim 7, wherein the display control unit is further configured to control a location of the display position of the virtual object based on luminance information about the captured image.

9. The display control device according to claim 7, wherein the display control unit is further configured to control a luminance of the displayed virtual object based on luminance information about the captured image.

10. The display control device according to claim 7, wherein the display control unit is further configured to control a location of the display position of the virtual object based on color information about the captured image.

11. The display control device according to claim 7, wherein the display control unit is further configured to control a color of the displayed virtual object based on color information about the captured image.

12. The display control device according to claim 7, wherein the display control unit is further configured to control a location of the display position of the virtual object based on a feature amount extracted from the captured image.

13. The display control device according to claim 1, further comprising:
an image acquisition unit configured to acquire a captured image captured by an imaging unit; and
a shading control unit configured to control a shading amount of the displayed virtual object based on luminance information about the captured image.

14. The display control device according to claim 1, wherein the display control unit is further configured to control a location of the display position in a depth direction of the virtual object presented to the user by controlling a position of display of a left eye image presented to a left eye of the user and a position of display of a right eye image presented to a right eye of the user.

15. The display control device according to claim 1, further comprising:
an image acquisition unit configured to acquire a captured image captured by an imaging unit,
wherein the display control unit is further configured to, when an object has been detected from the captured image, control a location of the display position of the virtual object presented to the user based on a position of the detected object.

16. The display control device according to claim 1, further comprising:
a viewpoint acquisition unit configured to acquire a viewpoint of the user detected by a viewpoint detection unit,
wherein the display control unit is further configured to move a location of the display position in a depth direction of the virtual object presented to the user further away, the further the detected viewpoint is from the user.

17. The display control device according to claim 16, wherein the acquired viewpoint is located in a direction of a gaze of the user and corresponds to a depth of the gaze.

18. The display control device, according to claim 1, further comprising:
a viewpoint acquisition unit configured to acquire a viewpoint of the user detected by a viewpoint detection unit,
wherein the display position of the virtual object is further being determined based upon the acquired viewpoint of the user.

19. The display control device according to claim 1, wherein at least one of a size and an orientation of the displayed virtual object is determined based on the acquired behavior of the user.

20. The display control device according to claim 1, wherein the display control unit is further configured to control the display unit to stereoscopically display the virtual object.

21. The display control device according to claim 1,
wherein the display control unit is configured to control the display unit to display, in correlation with a higher detected movement speed of the acquired behavior, at least one of a smaller amount of displayed content of the virtual object, a larger display size of the displayed content of the virtual object, and a display of the content of the virtual object to be more towards an edge portion of the virtual object.

22. The display control device according to claim 1, wherein the display position corresponds to a real world location and the virtual object is provided to be superimposed within the user's perceived view of the real world, the display position being determined based upon the acquired behavior of the user.

23. The display control device according to claim 1, further comprising:
a sensor unit configured to obtain sensor data pertaining to the user.

24. The display control device according to claim 1, further comprising:
an imaging unit configured to capture an image in a viewing direction of the user.

25. A display control method comprising:
acquiring a behavior of a user;
controlling a display unit to display a virtual object; and
controlling the display unit to display the virtual object at a display position having a depth that is perceivable by a user, the display position being determined based upon the acquired behavior of the user.

26. A non-transitory computer-readable recording medium having embodied thereon a program, which when executed by a computer causes the computer to perform a display control method, the method comprising:
acquiring a behavior of a user;
controlling a display unit to display a virtual object; and
controlling the display unit to display the virtual object at a display position having a depth that is perceivable by a user, the display position being determined based upon the acquired behavior of the user.
